(19) United States
(12) Patent Application Publication
(10) Pub. No.: US 2008/0126929 A1
(43) Pub. Date: May 29, 2008

(54) REMOTE UI FOR SMART DEVICES

(75) Inventor: Sergey Bykov, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/564,528

(22) Filed: Nov. 29, 2006

(51) Int. Cl. G06F 3/00

(52) U.S. Cl. 715/700

(57) ABSTRACT

The claimed subject matter relates to an architecture or arrangement that can facilitate a UI session between a smart device and a UI station in an application-agnostic manner. The UI station can expose a set of available peripherals to the smart device in order to provide the smart device with a richer user interface (UI) as well as additional features and/or options. Applications running on the smart device can utilize all or a subset of the available peripherals of the UI station for displaying (e.g., output peripherals) and navigating (e.g., input peripherals) the smart device's UI. As a result, smart devices that are smaller, less expensive, more durable, more convenient to carry, etc. can provide a user with a very feature-rich and/or intuitive UI.

### BACKGROUND OF THE INVENTION

The consumer and commercial markets for smart devices such as cellular phones, digital music players, Personal Digital Assistants (PDAs) and similar devices is rapidly growing and has been gaining momentum for some time. Advances in chip technology, ergonomics, user interface (UI) technology, software applications, and the like often spur additional growth potential as the smart devices become more powerful and capable of delivering more functionality, while at the same time becoming smaller, more convenient to carry around, and less expensive.

As a result, smart device have the potential to deliver a great deal of computational power, making them an attractive platform for mobile applications such as payments, identification, security, etc. For example, there have been multiple efforts to utilize cell phones as an electronic wallet, yet such attempts have highlighted some of the fundamental limitations such as small screen size, limited keyboard, short battery life, complex operation and/or high price due to the need to embed UI components in such a small form factor. These and other limitations can substantially hinder the utility and proliferation of smart devices.

In accordance therewith, the consumer and commercial markets for such smart devices are faced with challenges in which current trends in the area do not appear adequate to solve. In particular, users of smart devices desire simpler, smaller, less expensive devices, but on the other hand users also desire smart devices that can provide a richer set of functionality. Miniaturization of many smart devices has reached a point where the hardware necessary to deliver ample computing power for a rich set of features can be implemented in a durable and tiny housing roughly the size on a thumb-drive.

However, such a small conventional device is not capable of providing an adequate UI (e.g., display screen, input keys . . . ), and without an adequate UI, such small conventional devices are quite limited. For example, without the ability to easily navigate an intuitive UI, a smart device can be incapable of delivering the rich features the resident hardware and software might otherwise be capable of providing.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises computer-implemented techniques for facilitating a more robust user interface (UI) experience. In accordance with one aspect of the claimed subject matter, a smart device with a very limited UI (e.g., a small or no display screen and with just a few input mechanisms) can interface with a UI station (e.g., a device with a larger form factor and/or a richer set of IO and/or UI peripherals) in an application-agnostic manner in order to establish a UI session. In particular, the smart device configured with wireless capabilities can automatically detect UI stations within range and automatically discover a set of peripherals available on the UI stations.

Conversely, a UI station can expose extant peripherals to smart devices within communication range and allow those peripherals to be selected for use by the smart device. In accordance therewith, applications running on the smart device can utilize all or a subset of the available peripherals on the UI station. For example, output peripherals such as monitors or other displays, speakers, printing devices, etc. belonging to the UI station can be employed to display a UI for an application running on the smart device. Likewise, input peripherals of the UI station such as keyboards, pointing devices, biometric devices or the like can be utilized for collecting input for and/or navigating the UI provided by the smart device. In addition, the UI station can also provide a data store as one of the available peripherals for IO access. As a result, smart devices that are smaller, less expensive, more durable, more convenient to carry, etc. can provide a user with a very feature-rich and/or intuitive UI.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a smart device that can utilize remote resources in order to facilitate a more robust user interface (UI) experience.

FIG. 2 is an exemplary UI station that can share resources with remote devices in order to facilitate a richer UI environment.

FIG. 3 is a block diagram an exemplary architecture for a smart device and an exemplary architecture for a UI station.

FIG. 4 depicts a block diagram of example smart devices that can be employed in connection with the claimed subject matter.

FIG. 5 depicts a block diagram of example UI stations that can be employed in connection with the claimed subject matter.

FIG. 6 illustrates a block diagram of an example system that can employ an intelligence component in connection with at least one of the UI station and the smart device.

FIG. 7 is an exemplary flow chart of procedures that define a computer implemented method for facilitating a more robust UI experience.

FIG. 8 is an exemplary flow chart of procedures for a computer implemented method for employing a smart device to facilitate a richer UI experience.

FIG. 9 depicts an exemplary flow chart of procedures defining a computer implemented method for employing a UI station for facilitating a more robust UI environment.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “control”, “form”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

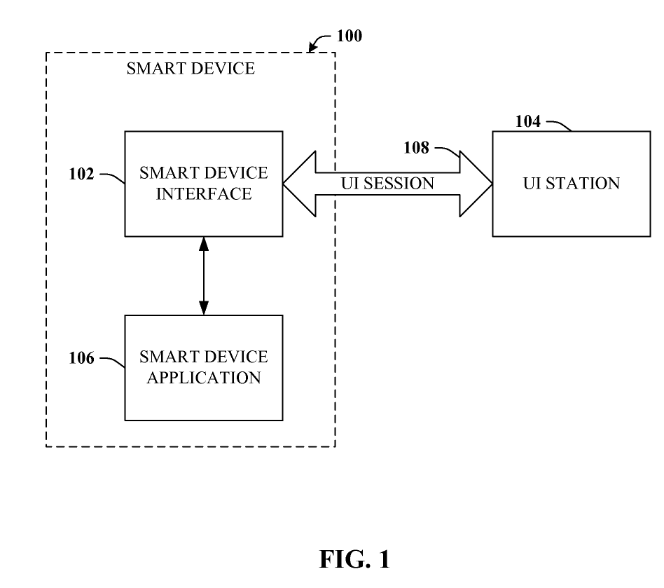

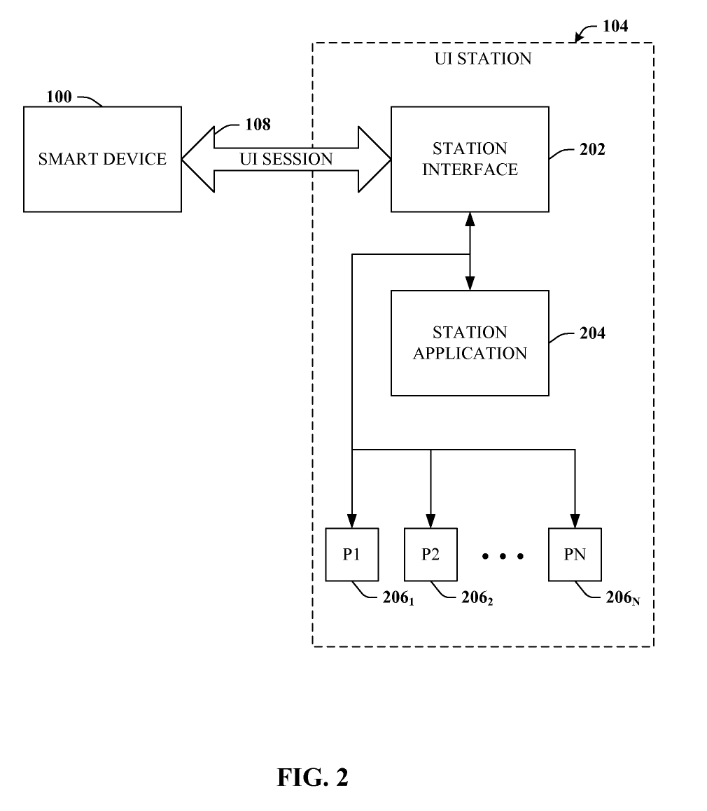

Referring now to the drawing, with reference initially to FIG. 1, a smart device 100 that can utilize remote resources in order to facilitate a more robust user interface (UI) experience is depicted. Generally, the smart device 100 can include a smart device interface 102 that can facilitate communication with a UI station 104. The UI station 104 can provide a much richer as well as a more intuitive UI for the smart device 100, as further detailed with reference to FIG. 2, infra. The smart device 100 can also include a smart device application 106 that can be configured to establish a UI session 108 with the UI station 104 in an application-agnostic manner.

Application-agnostic can mean, e.g., that no application-specific code need be installed on either the smart device 100 or the UI station 106 in order to establish and utilize the UI session 108. Rather, the smart device 100 and the UI station 106 can share resources as described herein according to a protocol such as one that defines various resources and/or peripherals as device classes that can react and respond to standard method calls. Thus, the application-agnostic UI session 108 (and/or the smart device interface 102) can facilitate a much more secure environment since the smart device application 106 operating on the smart device 100 need not share any private information or proprietary data with the UI station 104.

It is to be appreciated that the smart device 100 can be, e.g., any of a wide range of consumer or commercial electronic devices. For example, the smart device 100 can be a cellular phone, a Personal Digital Assistant (PDA), a key fob, an appliance, a contactless payment instrument, a watch, an organizer, a digital player/recorder, a digital camera, a pager, an electronic toy or game, a tablet, a scanner/reader, etc. Typically, the smart device 100 is a mobile or portable device and the UI station 104 is a stationary device such as a payment terminal or kiosk, however, that need not be the case, as detailed infra, such as in the case of, e.g., “smart” household appliances or the like.

With the growing trend of smaller, simpler, and/or cheaper devices, the UI for such devices is being increasingly reduced and/or becomes very complex or arcane for most users, even if an instruction manual is available. Conventionally, smaller form factor devices simply cannot accommodate a full-featured UI and the requisite small number of buttons (or other input mechanisms) on the device either precludes intuitive navigation of the UI or requires the UI to be necessarily simplistic. Thus, in accordance with the claimed subject matter, all or a portion of the UI functionality of the smart device 100 can be shifted to the UI station 104, which can have much richer UI capabilities. Accordingly, smart device 100 can have a very limited (or even no) built-in UI functionality, and still provide the user with a rich UI experience by way of the UI station 104. As a result, smart devices 100 that are smaller, cheaper, etc. can be proliferated without sacrificing (and in many cases actually dramatically improving) functionality or utility over larger and/or more expensive devices.

While still referencing FIG. 1, but turning briefly to FIG. 2, an exemplary UI station 104 that can share resources in order to facilitate a richer UI experience is illustrated. In general, the UI station 104 can include a station interface 202 that can facilitate communication with a smart device, such as smart device 100. In addition, the UI station 104 can include a station application 204 that can be configured to expose a set of peripherals 206₁-206_{N} to the smart device 100 in an application-agnostic manner. In accordance therewith, a UI session 108 can be established.

It is to be appreciated that there can be virtually any whole number, N, of peripherals 206₁-206_{N}. In addition, the peripherals 206₁-206_{N} can be referred to herein either individually or collectively as peripherals 206, although each individual peripheral 206 can have characteristics that distinguish it from other peripherals 206. It should also be appreciated that the peripherals 206 can be essentially any resource or device capable of interacting with the smart device 100, generally to aid in facilitating a richer UI experience for a user of the smart device 100.

For example, one or more of the peripherals 206 can be an output device such as a CRT display, an LCD, LED configuration or another type of display. In addition, the output device can be a speaker, a printer, or substantially any output resource suitable for use with the claimed subject matter. Additionally or alternatively, one or more of the peripherals 206 can be any of a wide variety of input devices as well. Examples of common input devices include but are not limited to a keyboard, keypad, touch screen, a mouse pad or another type of pointing mechanism, a fingerprint reader or other biometric device, a magnetic stripe reader (MSR) or another type of payment instrument reader. Furthermore, one or more of the peripherals 206 can be a data store or a file system data type such as a folder, directory, partition, etc.

Although depicted singularly, the UI station 104 can establish a UI session 108 with multiple smart devices 100 by way of the station interface 202. Moreover, the UI station 104 can include more than one station interface 202 in order to accommodate disparate types of smart device 100. For example, the station interface 202 can facilitate wireless communication with the smart device 100 (or even multiple smart devices 100, simultaneously) by way of Near Field Communication (NFC), WiFi (IEEE 802.11x specifications), Bluetooth (IEEE 802.15.x specifications), Radio Frequency Identification (RFID), infrared, or the like; e.g., including a separate station interface 202 for each particular protocol. In addition, the UI station 104 can also include one or more applicable hard wire station interfaces 202 for wired connections to the smart device 100, such as Universal Serial Bus (USB), FireWire (IEEE 1394 specification), etc.

The UI station 104 can generally be a stationary, a quasi-stationary, or even in some cases a mobile device. Example include but are not limited to a payment or informational terminal, a kiosk, a Personal Computer (PC), Pocket PC, a laptop, a console (e.g., a game console), or substantially any device of a more suitable form factor for providing a UI in accordance with the claimed subject matter. It is to be appreciated that the UI station 104 can perform a role that is in some ways similar to a server. That is, the UI station 104 can expose several or all of the peripherals 206 to the smart device 100. Upon establishing a UI session 108 with the smart device 100, output peripherals 206 can be employed to display a Graphical User Interface (GUI) associated with the smart device 100 and input peripherals 206 can be employed to, e.g., receive data provided by a user. In addition, such as in the case where the peripheral 206 is a data store, data can be communicated to and from the smart device 100 by way of the UI session 108.

In accordance therewith, it is to be noted that the UI station 104 need not be expressly intended to act as a UI station 104. Rather, the UI station 104 can be implemented for other purposes (e.g., a self check-in kiosk in an airport) that are particularly well-suited to providing a richer UI than smaller form factor devices such as smart device 100. For example, consider the following scenario in which a self check-in kiosk at an airport is implemented as UI station 104 and a traveler's cell phone is employed as smart device 100. The traveler can quickly see from the UI station 104 (e.g., the self check-in kiosk) that her flight has been delayed by six hours. While the UI station 104 itself is not equipped with a flight-scheduling application to reschedule her flight, the smart device 100 (e.g., the cell phone) can have a flight-scheduling application for just such a purpose (or, appreciably, one can be quickly downloaded to the smart device 100, potentially from the UI station 104 itself).

Conversely, while the smart device 100 can be employed to reschedule the traveler's flight, the limited form factor can make this task arduous and/or time-consuming to review the flight information for a list of available flights from the various carriers. However, the UI station 104 has readily available one or several larger display devices, a full-featured keyboard, as well as identity verification devices such as certificate/token readers, biometric devices or the like. Thus, the traveler can employ the flight-scheduling application or another application that runs on top of the flight-scheduling application as the smart device application 106. For example, by simply moving the smart device 100 within range of the UI station 104, the smart device can dynamically discover the peripherals 206 (e.g., the display screen, the keyboard, the ID authentication device . . . ) that are available.

The smart device 100 can then query whether the traveler wants to employ these peripherals 206 and, if so, create a UI session 108 between the smart device 100 and the UI station 104 (e.g., the cell phone and the self check-in kiosk). Now the traveler has a flight-scheduling application running safely and securely on her smart device 100, but can quickly and conveniently navigate the UI of the application by employing the richer peripherals 206 provided by the UI station 104. It is to be understood that the UI station 104 does not need to have any prior knowledge of or association with the flight-scheduling application or even what peripherals 206 the flight-scheduling application requires. In particular, the UI station 104 can simply share resources such as peripherals 206 and need not be provided any control over how those peripherals are used by the flight-scheduling application running on the smart device 100. The smart device application 106 can determine what peripherals 206 the flight-scheduling application requires, and discover whether these peripherals 206 (or suitable alternatives) are available. If so, and once the UI session 108 is established, the applicable peripherals 206 can be locked for use by the traveler.

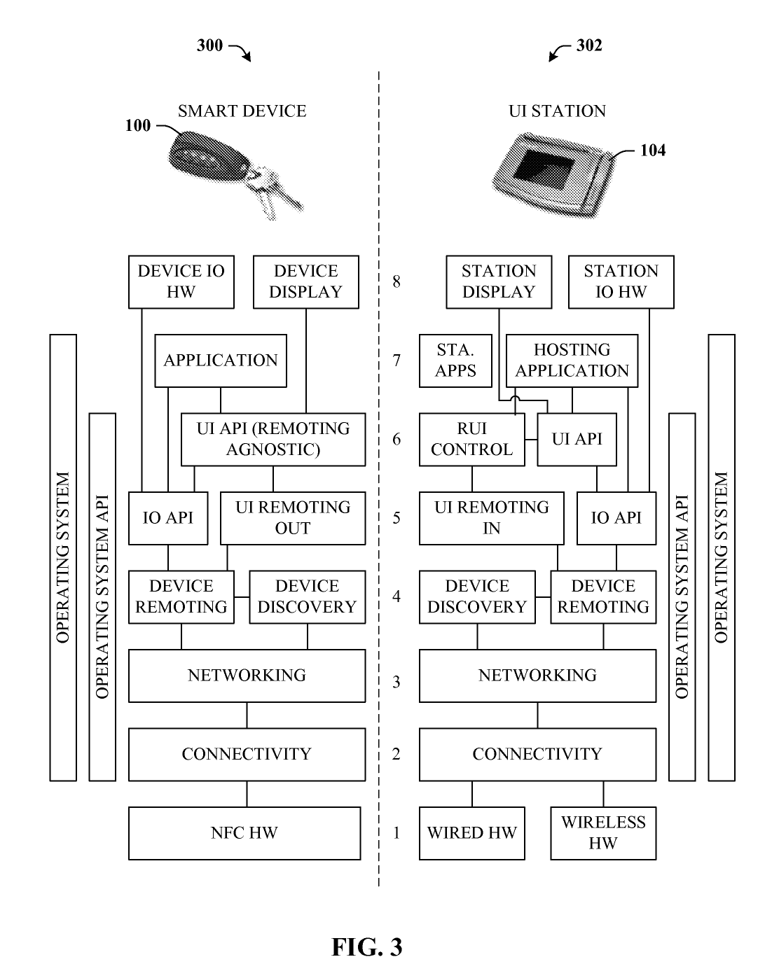

It is to be understood that the above example is illustrative in nature and not intended to limit the scope of the claimed subject matter. For example, the smart device 100 need not be a cell phone as described. Rather, virtually any electronic device with a similar general structure (e.g., a processor, RAM, flash memory, operating system . . . ) can be employed as smart device 100. Likewise, the UI station 104 can be a device other than a check-in kiosk. A possible architecture for both the smart device 100 and the UI station 104 is provided in FIG. 3, below.

Turning now to FIG. 3, an exemplary architecture 300 for a smart device 100 and an exemplary architecture 302 for a UI station 104 are illustrated. Respective layers (including both hardware and software) for the architectures 300 and 302 can be addressed by reference numerals 1-8 on the diagram. At reference numeral 1, the architectures 300, 302 can include communication hardware such as wireless hardware (e.g., NFC) as well as wired hardware (e.g., USB). For the sake of miniaturization concerns and/or convenience, the smart device 100 may have only NFC hardware (as depicted) although other embodiments could certainly exist.

NFC provides a very convenient protocol because it has a much lower power consumption than (and therefore can facilitate increased battery life over) other competing protocols (e.g., Bluetooth). In addition, NFC can also function in passive communication mode somewhat akin to passive RFID transponders, and thus draw power from a second (active mode) NFC-enabled device by way of an electromagnetic field generated by the second NFC-enabled device. Accordingly, it is conceivable in certain situations that a very feature-rich smart device 100 need not even include a battery or other conventional power source, making the smart device 100 potentially more economical to manufacture and more convenient to carry. Moreover, the relatively small range of NFC (typically up to about 8-10 inches or 20-25 cm.) can provide psychological reassurance to users of NFC-based smart devices 100, since communication and therefore potential tampering, hacking, hijacking, etc. cannot occur unless the two devices are in very close proximity.

On the other side, the UI station 104 may employ several types of hardware in order to handshake and/or establish a UI session (as described supra in connection with FIGS. 1 and 2) with many different classes of smart devices 100, although only one is sufficient. For example, the UI station 104 can have wireless hardware that supports one or more of NFC, Bluetooth, WiFi, etc. to interact with, say, small key fob smart devices 100 from different manufacturers, as well as wired USB hardware to, e.g., charge a battery for a connected cell phone or other smart device 100 in addition to facilitating the UI session.

At reference numeral 2, the connectivity layers can provide support for the associated hardware types (from reference numeral 1). In many cases, there are platform components already in existence to handle this aspect. However, in the case of NFC, the connectivity layers need to be extended to handle, e.g., Internet Protocol (IP) over NFC. At reference numeral 3, the networking layers are shown. The networking layers need not be changed over platform components that already exist.

On top of the networking layer, at reference numeral 4, two platform components are depicted. First, a device discovery protocol for smart devices 100 and UI stations 104 to locate one another, as well as to advertise IO capabilities. In accordance with one aspect, Universal Plug and Play (UPnP) can be leveraged to achieve a suitable discovery protocol, however other protocols are envisioned and are to be considered within the scope and spirit of the claimed subject matter. Also illustrated is a device remoting component, which can be, e.g., a generic protocol for communicating with physical and/or virtual IO peripherals attached to a remote device. The device remoting component can operate in a manner very similar to a Remote Desktop, which can provide local keyboard/mouse/sound, etc. available for a Remote Desktop Protocol (RDP) session on a remote machine. Accordingly, RDP can be leveraged to implement the device remoting component, but it is to be understood that other protocols can exist as well.

At reference numeral 5, both the smart device 100 and the UI station 104 can include an IO Application Programming Interface (API) to allow, for example, services to be requested and data exchange. The IO API can be used by applications for accessing local and remote IO peripherals such as keyboard, pen, biometric reader, or other resources, substantially described herein as peripherals 206. Additionally, the components 100, 102 can include a UI remoting protocol that can be based on any of a number of existing protocols including but not limited to Windows-brand Forms, .NET-brand Remoting, Extensible Application Markup Language (XAML), HTML, AJAX (Asynchronous JavaScript and XML), or the like.

At reference numeral 6, the smart device 100 can include a UI API, which can, e.g., employ conventional OS API components extended to support UI remoting. In such a case, the extended UI API can be fully compatible with the operating system platform and OS API framework and, thus, transparent to and/or seamless for applications running on the smart device 100. On the UI station 104 side, a Remoting UI Control can be implemented that can integrate the OS API control with the UI remoting, and can provide, e.g., rendering of the smart device 100 UI on UI station 104 peripherals 206 as well as user interaction with the UI. It is to be appreciated that the RUI control (and other controls described herein) as well as the forms described herein can be computer-related/programmatic components. For example, the RUI control can be substantially similar to conventional Web Browser controls. Essentially, a developer need only place a particular control on a form and the control will take care of everything else.

At reference numeral 7, applications running on the smart device 100 need not require any modification. In certain cases, windows, dialogs, and other UI features can be flagged for remotable display, e.g., by means of a special metadata attribute, and the extended UI API at reference numeral 6 can take care of the rest. The UI station 104 can include a hosting application for hosting the Remote UI control. The hosting application can be the only application on the UI station 104 or just one of several station applications, which can provide additional functionality. It is to be appreciated that certain hardware devices such as Pocket PCs are particularly well-suited to function as both a smart device 100 and a UI station 104. Accordingly, such devices can include features of both the smart device 100 and the UI station 104 simultaneously and, thus operate in connection with other components as a smart device 100 in some situations and as a UI station 104 in others.

Lastly, at reference numeral 8, hardware associated with a UI for each of the smart device 100 and the UI station 104 is depicted. This can include device IO hardware and device display hardware (e.g., keys, buttons, LEDs . . . for the smart device 100. For the UI station 104, the associated hardware can include a station display and a keyboard as well as many other resources/peripherals as described herein.

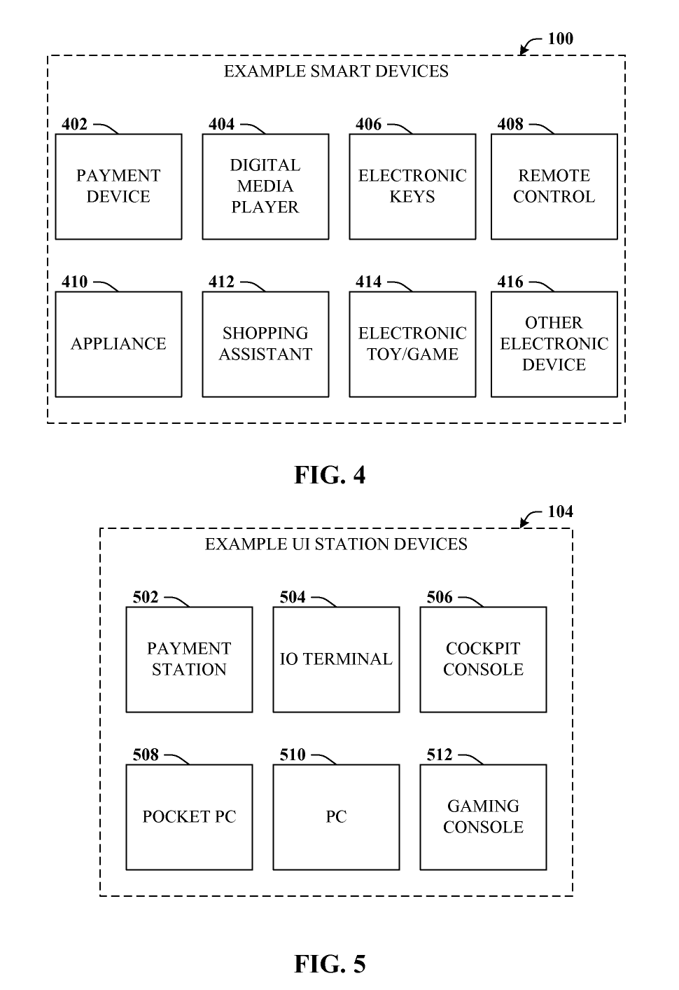

In order to provide additional context and to aid in understanding of the claimed subject matter, FIGS. 4 and 5 illustrate various exemplary electronic apparatuses that can be employed as smart devices 100 and/or UI stations 104. In addition, a number of scenarios are described, none of which should be viewed as limiting the claimed subject matter to one particular aspect, but rather as an exemplary illustration. It should be appreciated and understood that it is impossible to describe every potential implementation, however, those scenarios provided herein can amply illustrate the scope of the claims appended hereto.

Turning now to FIG. 4, a block diagram of example smart devices 100 is depicted. Included in these examples is a payment device 402 such as a credit card, debit card, or the like. It is to be noted that the payment device 402 need not be in the form of a more conventional card or smartcard, but can be implemented as, e.g., a key fob, which can be more rugged and durable than, say a smartphone with similar functionality. In addition, smart device 100 can be a digital media player 404, an electronic key 406, a remote control 408, an appliance 410, a shopping assistant 412, an electronic toy or game 414 as well as many other electronic devices 416. More detail regarding components 402-416 is provided infra in the use scenarios section.

Referring to FIG. 5, a block diagram of example UI stations 104 is illustrated. As with the example smart devices 100, example UI stations 104 can range from informational kiosks at a mall to a navigational console in a boat and virtually anything in between. Typical examples of UI station 104 can include (but are not limited to) a payment station 502, an IO terminal 504, a cockpit console 506, a Pocket PC 508, a PC 510, or a gaming console 512. Further detailed description of the various components 502-512 can be found in the scenarios section below.

### Scenarios

Smarter Credit Card

To reduce fraud, CreditCorp, a major credit card company has developed an application for a consumer electronic device operating system platform that generates single-use credit card numbers based on a customer's personal key. CreditCorp chooses to use a key fob device (e.g., payment device 402) produced by XYZ Unlimited as the cheapest platform for running the application. CreditCorp offers free key fob devices and an additional 1% cash back for key fob transactions as an incentive for customers to use this more secure form of credit card. Joe puts the smart device on his key chain and goes to his local supermarket.

To pay for his groceries, Joe places the smart device on the reader (e.g., payment station 502) that is built into a familiar signature capture terminal. As he does so, Joe sees that a window appears on the screen of the reader asking to confirm the transaction amount and to enter a security code to complete the transaction. Joe enters his security code by pressing buttons on the screen with a stylus. He is comfortable doing so because this process is very similar to how he pays with his debit card.

Joe returns to his home, attaches his key fob device to a USB port on his PC (e.g., PC 510), and starts his favorite personal financial application, which detects the device and downloads all of Joe's transactions. In addition to transaction totals, the financial software program can download information about purchased items so Joe can easily track how much he spends monthly.

Smarter Music Player

Jane likes to listen to music and she carries a tiny music player device (e.g., digital media player 404) with her everywhere. She can attach the music player to the lapel of her jacket, to sunglasses, or even to earrings due to the small form factor. Like Joe, she also uses the device in stores as a smart credit card. She particularly likes to work remotely from a local coffee shop near her house. One of the convenient features of coffee shop is an NFC-enabled UI device (e.g., IO terminal 504) built into their tables and bar countertops. Jane simply places her music player on the table and the UI of the player application running on the device can be displayed on the table screen. She can listen to new tracks while sitting at the table, buy songs she likes, and have those songs instantly uploaded to her player. When Jane plugs the player into her home PC (e.g., PC 510), the music player device recharges its battery and automatically synchronizes tracks between the device and her home PC music library.

Smarter Automobiles

Peter also has a tiny music player device (e.g., digital media player 404) very similar to Jane's. Recently he purchased a luxury automobile. While at the dealership, he was told by a dealer that for this new model any smart device carrying the “Be smarter” logo can be programmed to be a key for the car (e.g., electronic key 406). A proud owner of the car, Peter now touches the car door with his music player to unlock the driver-side door. When he gets into the car, he plugs the device into the “keyhole” (e.g., cockpit console 506) to start the engine. Peter no longer needs to carry a key or a remote. When plugged into the “keyhole,” the device charges its battery and synchronizes music between itself and the larger music library of the car stereo. The device also downloads diagnostic data from the car's computer system and logistics information from the onboard Global Positioning Satellite (GPS) system.

When Peter gets home, he plugs the player into a USB port of his computer (e.g., PC 510). The device communicates behind the scenes with the automobile manufacturer's automated customer support system to check on necessary maintenance and receives service coupons from local dealerships and/or certified automotive maintenance affiliates. The device uses the PC monitor to inform Peter about necessary or suggested actions like recalls or scheduled maintenance. In addition, when Peter plans his next vacation or business trip with travel software of his choice, he can upload the route to the music player device and have the directions automatically appear on the car's navigation system. Later, the travel software can automatically download information about Peter's trips that was saved on the music player device by the car's navigation system. Over time, as the travel software collects data, drive times can be more accurately predicted and better alternative routes can be propose based upon the day of week, the time of day, etc.

Smarter Remote Controls

Cathy just bought a brand new music player device (e.g., digital media player 404). Although not as small as Peter or Jane's music player, she can carry a lot of music with her anywhere she goes. Cathy takes the device to the local gym (where cell phones are banned), uses it as a key (e.g., electronic key 406) for her locker, and pays for lunch at the café with it (e.g., payment device 402). She also programmed the “nano” device (e.g., remote control 408) to open her garage door, control her TV, Media Center PC, temperature, lighting, and everything else that is remotely controlled in her house. Of course, she also opens the front door of her house with the device. Essentially, the smart “nano” device is a central piece of Cathy's day-to-day life, without which it would be troublesome to cope, however, Cathy is not too worried about losing the device because she has a backup of everything on her home PC (e.g., PC 510) and can easily restore it on a new device. Moreover, data on the device is encrypted and can only be accessed after Cathy's finger is scanned by the device's biometric reader.

Smarter Appliances

A well-known household appliance manufacturer wants to reduce the fault rate of their appliances, to lower the cost of warranty repair, and to improve customer satisfaction. They built a new generation of their appliances with controllers built on a platform in accordance with a smart device 100 platform disclosed herein. The controllers accumulate statistics, analyze trends in appliance behavior, and signal when they need scheduled maintenance. Warned by a signal on his recently purchased “Smart Fridge” (e.g., appliance 410) Chris contacts the service department, and a technician from the appliance manufacturer arrives the next morning.

The technician touches the refrigerator with a Pocket PC (e.g., Pocket PC 508) and a window of the refrigerator controller's application is displayed on the Pocket PC screen. It indicates the compressor is steadily losing pressure, so the technician fixes the compressor. Chris is curious about the diagnostics technique, and the service technician explains that the recent trend in the industry is to standardize to the smart device 100 platform. He notices that Chris's dishwasher also carries the “Be smarter” logo (indicating the same smart device 100 platform), although the dishwasher was not manufactured by the service technician's company, but rather produced by a competing appliance manufacturer.

To illustrate the potential of this robust technology, the service technician connects the dishwasher with his Pocket PC just as he had previously done for the refrigerator (e.g., either by moving it within range of the wireless hardware, with a wired connection, or another means, as substantially described herein). A window pops up on the screen of the Pocket PC, indicating the dishwasher is in good shape, but it also recommends reducing the amount of detergent by a third based on its water analysis. The technician explains that he knows nothing about the competitor's appliances and that there is no custom software on his Pocket PC associated with that competitor, but because of the “Be smarter” standard he can perform basic diagnostics and configuration of other smart appliances.

Smarter Toys and Games

ToyCo, a prominent toy manufacturer wants to repeat the immense success of Tamachi 2.0, its prolific virtual pet. ToyCo wants the new Tamachi 3.0 (T3) to have a better way to express itself than the small mono LCD display, to be able to roam around like a Rumba-brand vacuum, take pictures with a built-in camera, and initiate conversations with its owner by leveraging its advanced artificial intelligence engine. Building a proprietary platform will take a year of R&D which puts them at risk of missing the market opportunity due to stiff competition. ToyCo decides to use the “Be smarter” platform as it has a multitasking OS, rich API, remote UI capabilities, and built-in support for a digital camera. After three months of R&D, Bandai puts together the toy and starts production.

T3 is a killer toy worldwide. In addition to the functionality of its predecessors, it can slowly roam around and build a map of the owner's house. When it senses the Bluetooth signal of a UI station 104 device like a personal computer 510, Pocket PC 508, gaming console 512, or a “smart TV,” it may decide to try to start a conversation by way of the screen on the associated UI station 104. If T3 is in a good mood, it can even use the gaming console 512 graphics capabilities to show a “quest” game based on the 3D model of the house it has created while roaming, potentially employing real photos as textures for the model. T3 can also go outside the house and meet and communicate with neighbors' “pets”.

Other Smarter Devices

A potential benefit of the architectures described herein can be that the smart device 100 can have a display screen of any size whether it be a color graphic screen, a two-line LCD, or no screen at all. Similarly, the smart device 100 can have a keyboard of any size, be it a Pocket PC keyboard, a small number of buttons, or even no keyboard at all, yet still have the capability to offer a robust UI to the user. In addition, the smart device 100 does not necessarily need to include cellular or WiFi hardware, but rather can include NFC hardware alone and still provide a feature-rich solution for payment and/or identification transactions or the like.

It is to be appreciated that with no minimum size constraints for the relevant UI hardware (e.g., screen or keyboard) and no requirement to include cellular or WiFi hardware, the smart device 100 can be less expensive to produce, more affordable to consumers. In addition, such smaller form factor smart devices 100 will generally consume much less power during operation, and as long as there is no feature otherwise implemented in the smart device 100 (e.g., phone service) it can be turned off or set to a sleep mode to further conserve power and/or battery life. Accordingly, the aforementioned features can thus provide very desirable and prolific branding potential for a wide range of new smart devices 100.

Examples of possible new device (e.g., other electronic devices 416) form factors can include but is not to be limited to the following list of examples:

A Key Fob Device

Approximately the size of a USB thumb-drive. The key fob device need not have any display. Rather the key fob device can include, e.g., two LED indicators (e.g., red and green) to indicate whether the device is on or off as well as to show progress/result of a transaction. No keyboard is required either, but an on/off button can be provided. A USB port for connecting to PC can be a standard feature as well.

A “Micro” Device.

A digital music player/recorder approximately the size of a small matchbook. No display is required, but rather a few LEDs (red and green) can be visible to indicate whether the device is on/off and to show progress/result of a transaction. Buttons can be provided to control the music player and a USB port for connecting to a PC.

A “Mini” Device.

A digital music player and a programmable remote control. Approximately the size of a pack of chewing gum with a mono LCD display. Buttons to control the music player such as arrows; ENTER, a few programmable keys, etc. and in addition, a built-in fingerprint reader.

Other Devices

Built-in controllers for appliances such as refrigerators, microwave ovens, dishwashers, air conditioners, furnaces, and the like. Toys and gaming devices. Industrial controllers and robots. There exist many other possibilities as well, however, what has been described herein can be used to apprise one of the scope and spirit of the claimed subject matter.

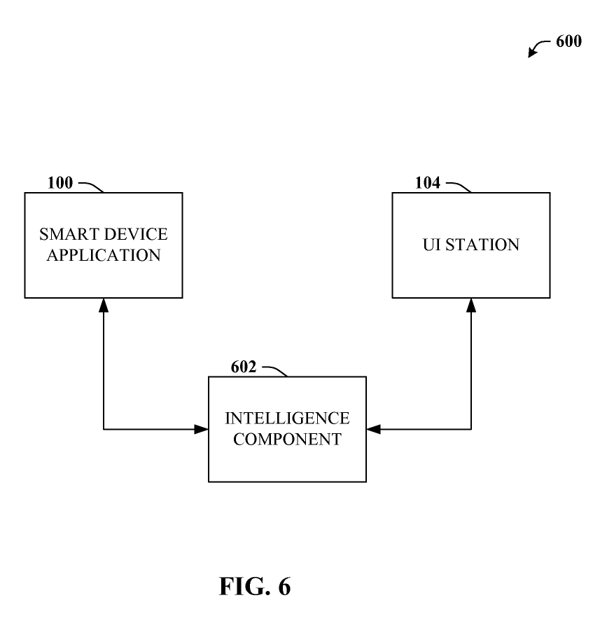

With reference now to FIG. 6, a system 600 that facilitates smarter inferences can be found. In general, the system can include an intelligence component 602 and at least one of the smart device 100 or the UI station 104. The intelligence component 602 can be operatively coupled to the smart device 100 or to the UI station 104 as depicted. In addition, the intelligence component 602 can be embedded in either or both of the smart device 100 or the UI station 104. Typically, the intelligence component 602 can aid in various determinations or inferences. For example, the intelligence component 602 can interact with an application running on the smart device 100 and determine what peripherals must be available on the UI station 104, e.g., given the nature of the application or even the UI features extant on the smart device 100. In certain cases, the application may have a predetermined list of required peripherals, some of which may not exist or may not be currently available on the UI station 104. However, the intelligence component 602 may be able to ascertain a suitable alternative peripheral that is available and can be used instead. In addition, the intelligence component 602 can be employed to examine histories, stochastic information, empirical data, or the like that can relate to applications, device classes, etc. in order to provide useful inferences such as those described in connection with the “Smarter Automobile” scenario.

In particular, the intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

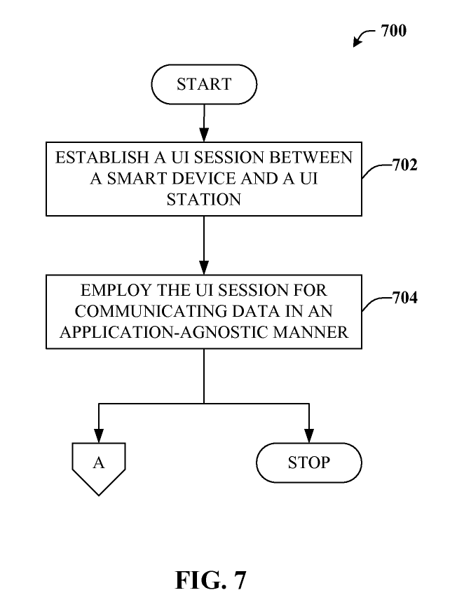

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, an exemplary computer implemented method 700 for facilitating a more robust UI experience is depicted. In general, at reference numeral 702, a UI session can be established between a smart device and a UI station. Typically, the smart device is a portable consumer electronic device such as a cell phone, a key fob, etc. and the UI station is typically a stationary device with larger form factor IO peripherals such as a payment station or kiosk, etc. However, the typical roles need not always apply and in some cases can be reversed, for example, with smart appliances (e.g., relatively stationary smart devices) interact with a Pocket PC (e.g., a portable UI station), as substantially described supra.

At reference numeral 704, the UI session can be employed for communicating data in an application-agnostic manner. As such, no application-specific code is required to be previously installed on either the smart device or the UI station. Moreover, the UI station and the smart device can potentially communicate and function in a symbiotic manner irrespective of design implementation details, intended purposes or markets, or respective manufacturers. It is to be appreciated that despite the aforementioned fact, the UI station and the smart devices can, of course, be specifically designed to function together in order to provide a richer UI experience as well as for various other ends, many of which have been described herein.

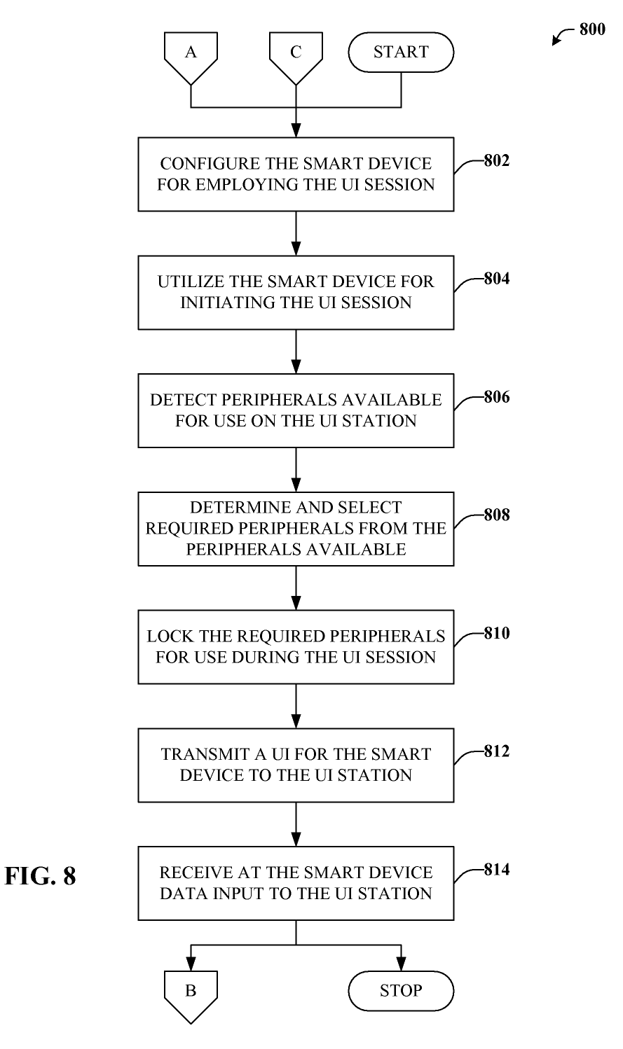

Referring now to FIG. 8, there is illustrated an exemplary flow chart of procedures for a computer implemented method 800 for employing a smart device to facilitate a more robust UI experience. At reference numeral 802, the mobile device can be configured for employing the UI session. For example, the mobile device can be configured to effectively employ a communication session in an application-agnostic manner. At reference numeral 804, the mobile device can be utilized for initiating the UI session. Conventional devices that facilitate communication sessions between a mobile device and a station device typically rely upon a master/slave architecture, wherein the master (e.g., station device) detects the slave (e.g., mobile device) and initiates a communication session based upon application-specific code running on both devices. In contrast, in accordance with an aspect of the claimed subject matter, the smart device can initiate the UI session by, e.g., simply entering into wireless range.

At reference numeral 806, peripherals available for use on the UI station can be detected. In some situations, certain peripherals may exist on the UI station, but are not currently available because they are, e.g., in use by other applications or other smart devices, etc. At reference numeral 808, the peripherals to be employed by the application running on the smart device can be determined and selected from the peripherals available on the UI station. It is to be appreciated that this determination can be based upon a predetermined list as well as based upon inferences intelligently determined.

At reference numeral 810, the peripherals to be employed by the application running on the smart device can be locked for use for the duration of the UI session. In accordance with an aspect, a peripheral can be released before the UI session terminates such as when the peripheral in question is no longer necessary for the application. At reference numeral 812, a UI for the smart device can be transmitted to the UI station. The UI station can then employ peripherals under the control of the UI station to display the UI for the smart device. At reference numeral 814, the smart device can receive data input to the UI station, e.g., by way of the input peripherals provided by the UI station.

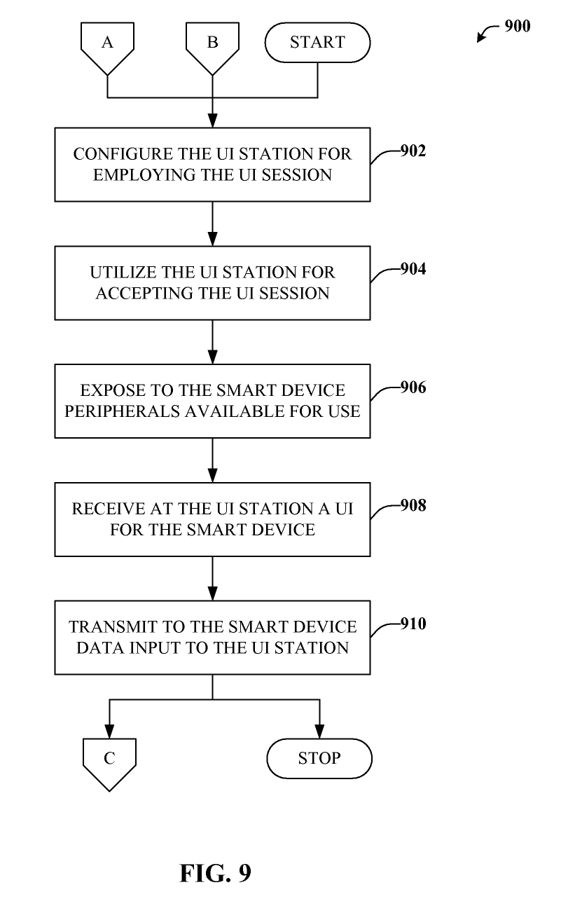

Turning now to FIG. 9, an exemplary flow chart of procedures for a computer-implemented method 900 for employing a UI station to facilitate a richer UI experience is depicted. At reference numeral 902, the UI station can be configured for employing the UI session in an application-agnostic manner. At reference numeral 904, the UI station can be utilized for accepting the UI session, for example, after the smart device initiates the UI session.

In accordance therewith, at reference numeral 906, the UI station can expose to the smart device all the peripherals residing on the UI station as well as those peripherals that are currently available for use. At reference numeral 908, the UI station can receive a UI for the mobile device. The UI can then be displayed on output peripherals present on the UI station. In addition, the UI can be navigated by input peripherals present on the UI station. Accordingly, at reference numeral 910, data input to (e.g., input peripherals of) the UI station can be transmitted to the smart device.

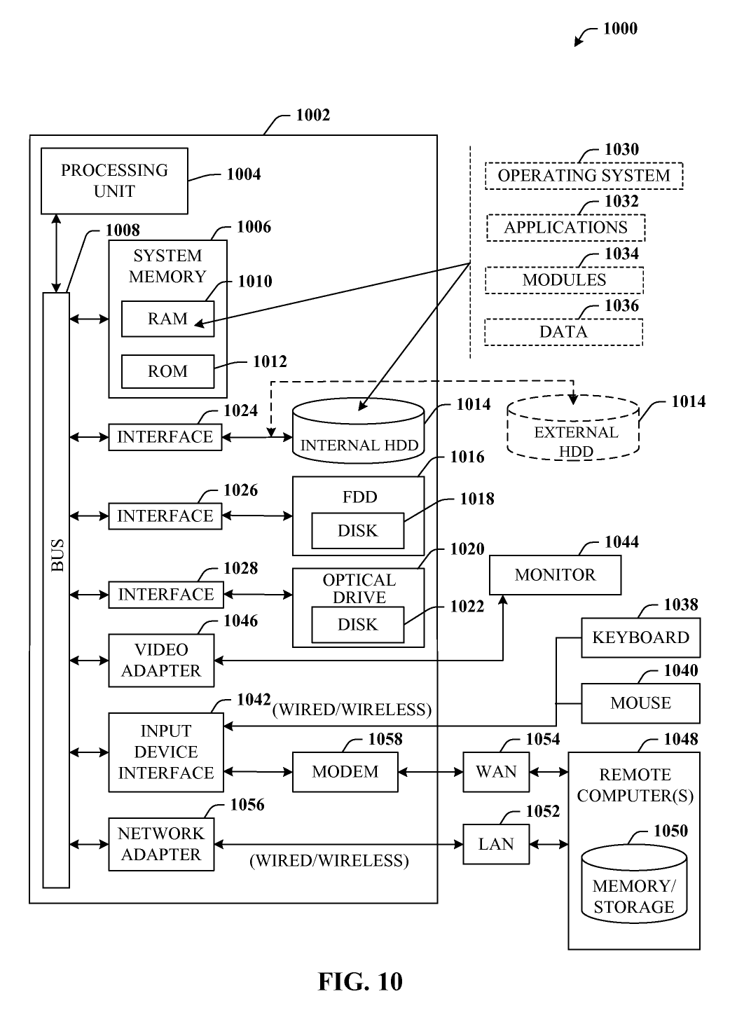

Referring now to FIG. 10, there is illustrated a block diagram of an exemplary computer system operable to execute the disclosed architecture. In order to provide additional context for various aspects of the subject invention, FIG. 10 and the following discussion are intended to provide a brief, general description of a suitable computing environment 1000 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the invention includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

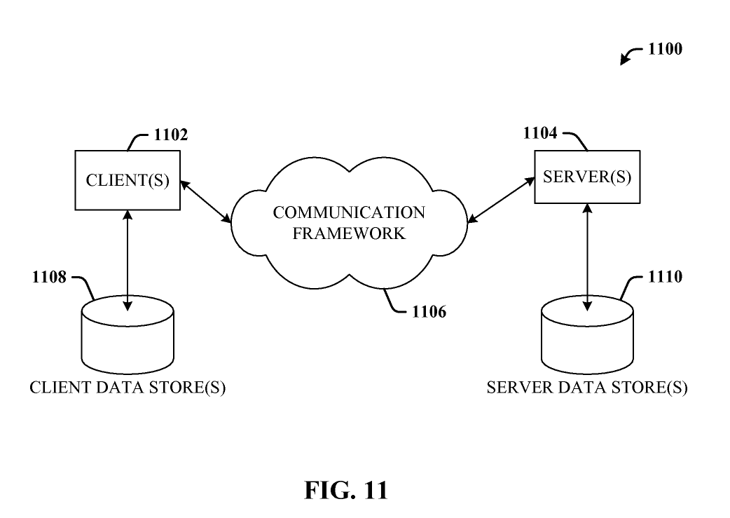

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the invention, for example.

The system 1100 also includes one or more server(s) 1104. The server(s) 1104 can also be hardware and/or software (e.g., threads, processes, computing devices). The servers 1104 can house threads to perform transformations by employing the invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A smart device that utilizes remote resources in order to facilitate a more robust user interface (UI) experience, comprising:
a smart device interface that facilitates communication with a UI station; and
a smart device application configured to establish a UI session with the UI station in an application-agnostic manner.

2. The device of claim 1, the smart device application automatically discovers a set of peripherals available on the UI station.

3. The device of claim 2, the smart device application automatically determines a subset of the set of peripherals available to utilize in connection with the UI session.

4. The device of claim 3, the smart device application utilizes at least one of the subset of peripherals to display a smart device UI.

5. The device of claim 3, the smart device application utilizes at least one of the subset of peripherals to receive input.

6. The device of claim 3, the smart device application locks at least one of the subset of peripherals during use.

7. The device of claim 1, the smart device application initiates the UI session with the UI station.

8. The device of claim 1, the UI session is encrypted for secure communication.

9. The device of claim 1, the smart device interface communicates with the UI station wirelessly in accordance with at least one of a Near Field Communication (NFC) standard or Radio Frequency Identification (RFID) standard.

10. The device of claim 1, the smart device interface communicates with the UI station wirelessly in accordance with at least one of an IEEE 802.11 specification or IEEE 802.15 specification.

11. The device of claim 1, the smart device interface communicates with the UI station by way of a Universal Serial Bus (USB).

12. A UI station that shares resources in order to facilitate a richer UI environment, comprising:
a station interface that facilitates communication with a smart device; and
a station application configured to expose a set of peripherals to a smart device in an application-agnostic manner.

13. The station of claim 12, the station application accepts a UI session with the smart device.

14. The station of claim 12, the set of peripherals includes at least one of an input device, an output device, or a data store.

15. The station of claim 14, the output device displays a UI of the smart device.

16. The station of claim 14, the input device receives input and transmits the input to the smart device.

17. The station of claim 14, the data store transmits data to the smart device.

18. A computer-implemented method for facilitating a more robust UI experience, comprising:
establishing a UI session between a smart device and a UI station; and
employing the UI session for communicating data in an application-agnostic manner.

19. The method of claim 18, further comprising at least one of the following acts:
configuring the smart device for the act of employing;
utilizing the smart device for initiating the UI session;
detecting peripherals available for use on the UI station;
selecting required peripherals from the peripherals available;
locking the required peripherals for use during the UI session;
transmitting a UI for the smart device to the UI station; or
receiving at the smart device data input to the UI station.

20. The method of claim 18, further comprising at least one of the following acts:
configuring the UI station for the act of employing;
utilizing the UI station for accepting the UI session;
exposing peripherals available for use by the smart device;
receiving a UI for the smart device to the UI station; or
transmitting to the smart device data input to the UI station.
